(19) United States
(12) Patent Application Publication
(10) Pub. No.: US 2002/0079435 A1
(43) Pub. Date: Jun. 27, 2002

(54) Automatic optical level adjuster and optical signal receiving system having the adjuster

(76) Inventor: Jun Kuroshima, Tokyo (JP)

Correspondence Address: YOUNG & THOMPSON, 745 SOUTH 23RD STREET 2ND FLOOR, ARLINGTON, VA, 22202

(21) Appl. No.: 10/025,466

(22) Filed: Dec. 26, 2001

(30) Foreign Application Priority Data
Dec. 25, 2000 (JP) 393305/2000

(51) Int. Cl. G01J 1/34

(52) U.S. Cl. 250/227.21

(57) ABSTRACT

An automatic optical output level adjuster has a plurality of couplers for branching an optical signal, an optical switch for switching optical signal paths, a variable attenuator for attenuating the optical signal, a variable optical amplifier for amplifying the optical signal, photodetectors, and a CPU for control. The photodetectors detect the level of an optical input to the automatic optical output level adjuster and the level of an optical output from the adjuster. The CPU controls the optical switch on the basis of the detected optical input level and controls the amount of attenuation by the variable attenuator or the optical output from the variable amplifier on the basis of the detected optical output level. In a wavelength-multiplex optical transmission receiving system having the automatic optical output level adjuster inserted between a dispersion compensating fiber and an optical receiver, the level of an optical signal input to the optical receiver is automatically adjusted to an optimum light receiving level even when the set value of the amount of dispersion compensation by the dispersion compensating fiber is changed.

### BACKGROUND OF THE INVENTION

1. Field of the Invention

The present invention relates to an automatic optical output level adjuster board for automatically adjusting the level of an optical output and to a wavelength-multiplex optical transmission receiving system using the adjuster board and having a wavelength dispersion compensating function.

2. Description of the Related Art

In the development of high-capacity high-speed wavelength-multiplex optical communication systems using an optical fiber as a transmission path, the number of wavelengths to be multiplexed is increasing steadily. Also, usable wavelength ranges are being increased and use of the 1.58 μm band on the longer wavelength side of the 1.55 μm band is being planned. If a single mode optical fiber having a zero-dispersion wavelength close to 1.3 μm is used as an optical transmission path for long-distance transmission, and if an optical signal in the above-mentioned wavelength band shifted from this zero-dispersion wavelength is transmitted through this optical path at a high rate, distortion in waveform occurs as a deterioration in transmission characteristics due to a wavelength dispersion characteristic of the transmission path.

In wavelength-multiplex optical communication systems for such long-distance high-speed transmission, compensation for wavelength dispersion in the transmission path is ordinarily performed for the purpose of limiting waveform distortion. However, it is not always possible to determine the amount of dispersion compensation at the system design stage. ordinarily, an approximate compensation amount is set at the system design stage and a final compensation amount is determined after the completion of installation work.

In a most common dispersion compensation method, an optical signal transmitted over an optical fiber transmission path is passed through a dispersion compensating means before being received by an optical signal receiver. Dispersion compensating fibers are ordinarily used as dispersion compensation means. A dispersion compensating fiber is an optical fiber designed so as to have a slope which is the reverse of the dispersion slope of the 1.3 μm zero-dispersion single mode optical fiber.

Even if compensation for wavelength dispersion is performed to reduce waveform distortion, another problem arises. That is, even if optical power input to a dispersion compensating fiber is constant, the level of the optical signal input to an optical receiver in the following stage changes depending on the amount of dispersion compensation by the dispersion compensating fiber to be inserted.

This problem is particularly serious in the case of receiving a wavelength-multiplexed optical signal. In a system shown in FIG. 1, a received wavelength-multiplexed optical signal is collectively compensated for dispersion by a dispersion compensating fiber CSF 1, and different wavelengths of signal light are successively separated by optical branching couplers WCPL 1 to WCPL n to be received by optical signal receivers ORC 1 to ORC n. In this system, if the amount of dispersion compensation at a former one of the stages is changed, the effect ripples through the following stages. Therefore it is necessary to set amplification and attenuation characteristics at each stage by using an optical amplifier AMP, an optical attenuator ATT or the like according to the amount of dispersion compensation performed at the stage in order to uniformize the levels of inputs (Pin 1 to Pin n) to the optical signal receivers ORC after dispersion compensation.

A concrete example of the numeric values of such characteristics will be described. FIG. 2 shows an example of three-wave multiplexing. The system shown in FIG. 2 has dispersion compensating fibers CSF inserted at a plurality of stages for collective dispersion compensation of a received wavelength-multiplexed optical transmission signal, optical branching couplers WCPL provided in stages between the CSF, and optical signal receivers ORC for receiving optical signals of different wavelengths respectively wavelength-separated by the optical branching couplers WCPL. In this dispersion compensation system, dispersion compensation amounts are finely set with respect to the wavelengths of light by using the plurality of dispersion compensating fibers CSF 1 to CSF n. At the stage of designing the optical receiving apparatus, the range of adjustment of dispersion compensation by the dispersion compensating fiber CSF 1 is set to 0 to 1500 ps/nm/km; the range of adjustment of dispersion compensation by each of the dispersion compensating fibers CSF 2 and CSF 3 is set to 0 to 1000 ps/nm/km; the output from an optical amplifier AMP 1 is set to +0 dBm; the amount of attenuation by each dispersion compensating fiber is set to 0.01 dB/km; and the loss due to insertion of each of the optical branching couplers WCPL 1 and WCPL 2 is set to 3 dB, as shown in FIG. 2. Also, the levels of optical signal inputs to the optical signal receivers 1 to 3 are set to −5 to −15 dBm, and actual dispersion compensation amounts are determined according to the characteristics of the transmission path after the installation of the apparatus.

It is assumed here that the amounts of dispersion compensation by the dispersion compensating fibers determined according to the characteristics of a transmission path after the installation of the apparatus are as shown in FIG. 3, that is, the amount of dispersion compensation by the dispersion compensating fiber CSF 1 is 1500 ps/nm/km; the amount of dispersion compensation by the dispersion compensating fiber CSF 2 is 750 ps/nm/km; and the amount of dispersion compensation by the dispersion compensating fiber CSF 3 is 600 ps/nm/km. If the amount of dispersion compensation by each dispersion compensating fiber is determined as described above, the amounts of attenuation of light newly generated in the dispersion compensating fibers CSF 1 to CSF 3 are 15 dB, 7.5 dB, and 7.5 dB, respectively. Then, in order to set the light receiving levels of the optical receivers ORC within the range of −5 to −15 dBm, it is necessary to newly add optical amplifiers AMP 2 and AMP 3 and a variable optical attenuator VATT to the arrangement shown in FIG. 2, to adjust the gains of the optical amplifiers AMP 2 and AMP 3 to +15 dB and +13.5 dB, respectively, and to adjust the amount of attenuation by the attenuator VATT to −2 to −12 dB.

In another case where after installation of the apparatus the amount of dispersion compensation by the inserted CSF 1 is 500 ps/nm/km and the amounts of dispersion compensation by the CSF 2 and CSF 3 are 0 ps/nm/km, it is necessary to provide a system arranged as shown in FIG. 4, which is obtained by removing the AMP 2, CSF 2, AMP 3, and CSF 3 from the system shown in FIG. 3.

Thus, in constructing the conventional system, it is necessary to prepare instruments and devices constituting the optical receiving apparatus by considering all combinations of dispersion compensation amounts in order to adapt the apparatus to any characteristics of a transmission path. There is also a need for operations for adjusting the optical output according to each dispersion compensation amount.

### SUMMARY OF THE INVENTION

The present invention has been made to solve the above-mentioned problem, and an object of the present invention is to provide a wavelength-multiplex optical transmission receiving system that constructs an automatic optical output level adjuster board which can keep an output level of the optical signal constant regardless of an input level of the optical signal, in which there is no need for optical output level adjustment operations through suitably combining the dispersion compensation means and the automatic optical output level adjuster board according to a dispersion compensation amount set after the completion of installation work.

An optical signal receiving system according to the present invention, in which a receiving signal light which is transmitted through a single mode fiber having a zero-velocity-dispersion wavelength and has a wavelength different from the zero-dispersion wavelength, is received while performing dispersion compensation on the signal light, includes automatic optical level adjustment means for automatically adjusting always to a predetermined level the level of optical signal to be received by the optical receiving means when the amount of dispersion compensation on the signal light is newly set. The predetermined level is an optimum light receiving level of the light receiving means. The optical signal is a wavelength-multiplexed optical signal and has a plurality of the light receiving means and the automatic optical level adjustment means in combination with each of the plurality of the light receiving means.

An automatic optical level adjuster according to the present invention, for automatically adjusting always to a predetermined level the level of a signal to be received by light receiving means, includes: a variable optical attenuator for changing the amount of attenuation of light on the basis of first control information; a variable optical amplifier for variably producing an optical output according to second control information; optical switch means for switching on the basis of third information between an output optical path for output of input light by transmission through the variable optical attenuator and an output optical path for output of input light by transmission through the variable optical amplifier; and control means for controlling the level of light output from each of the output optical paths to a preset level by outputting the third control information from comparison information obtained by comparing the level of the input light with a preset level, and the first or second control information from comparison information obtained by comparing the level of light output from the output optical path with a preset level. The level preset with respect to the input light and the level preset with respect to the light are stored in the control means, or these levels are set from the outside of the optical output level adjuster.

Further, the optical switch means includes: a one-input two-output optical switch for selectively inputting the input light to the variable optical attenuator or the variable optical amplifier; and an optical coupler for combining the output of the variable optical attenuator and the output of the variable optical amplifier into one output. Another optical switch means includes: a one-input two-output optical switch for selectively inputting the input light to the variable optical attenuator or the variable optical amplifier; and a two-output one-input optical switch for selectively establishing a connection for obtaining one output from the output of the variable optical attenuator and the output of the variable optical amplifier. Still another optical switch means includes: a one-input two-output optical branching device for simultaneously inputting the input light to the variable optical attenuator and to the variable optical amplifier; and a two-output one-input optical switch for selectively establishing a connection for obtaining one output from the output of the variable optical attenuator and the output of the variable optical amplifier.

Further, an optical signal receiving system according to the present invention, includes the automatic optical level adjustment means having: a variable optical attenuator for changing the amount of attenuation of light on the basis of first control information; a variable optical amplifier for variably producing an optical output according to second control information; optical switch means for switching on the basis of third information between an output optical path for output of input light by transmission through the variable optical attenuator and an output optical path for output of input light by transmission through the variable optical amplifier; and control means for controlling the level of light output from each of the output optical paths to a preset level by outputting the third control information from comparison information obtained by comparing the level of the input light with a preset level, and the first or second control information from comparison information obtained by comparing the level of light output from the output optical path with a preset level.

Another optical signal receiving system according to the present invention, includes a dispersion-compensating light receiving means forming a plurality of stages having: dispersion compensation means for performing dispersion compensation on the wavelength-multiplexed input signal light; the automatic optical level adjustment means through which output light from the dispersion compensation means is transmitted; wavelength demultiplexing means for separating output light from the automatic optical level adjustment means into first light which is signal light of a particular wavelength and second light left after removal of the first light; and the light receiving means for receiving the first light, in which the dispersion-compensating light receiving means in the plurality of stages are connected in cascade form such that the second light in one of the stages is supplied as the input signal light to the dispersion compensation means in the following stage. The wavelength demultiplexing means includes a fiber grating for reflecting the first light, and an optical circulator. The optical circulator has three terminals.

Another optical signal receiving system according to the present invention, includes a dispersion-compensating light receiving means forming a plurality of stages having: dispersion compensation means for performing dispersion compensation on the wavelength-multiplexed input signal light; wavelength demultiplexing means for separating output light from the dispersion compensation means into first light which is signal light of a particular wavelength and second light left after removal of the first light; the automatic optical level adjustment means through which the first light is transmitted; and the light receiving means for receiving the light transmitted through the automatic optical level adjustment means, in which the dispersion-compensating light receiving means in the plurality of stages are connected in cascade form such that the second light in one of the stages is supplied as the input signal light to the dispersion compensation means in the following stage. The wavelength demultiplexing means includes a fiber grating for reflecting the first light, and an optical circulator. The optical circulator has three terminals.

Further, still another optical signal receiving system according to the present invention, includes: wavelength demultiplexing means for obtaining parallel demultiplexing outputs from a wavelength-multiplexed input signal; a plurality of dispersion compensation means for performing the dispersion compensation on the output light from the wavelength demultiplexing means; a plurality of the automatic optical level adjustment means through each of which output light from the corresponding one of the dispersion compensation means is transmitted; and a plurality of the light receiving means each for receiving output light from the corresponding one of the automatic optical level adjustment means. The wavelength demultiplexing means is constituted by one of an arrayed waveguide Bragg diffraction grating type of wavelength demultiplexing device (AWG), a device having a plurality of stages formed by optical filters using a dielectric multilayer film, and a device having a plurality of stages each formed of a combination of a fiber grating and an optical circulator. The optical circulator has three terminals.

### BRIEF DESCRIPTION OF THE DRAWINGS

The above and other objects, features and advantages of the present invention will become apparent from the following detailed description when taken with the accompanying drawings in which:

FIG. 1 is a block diagram of a basic configuration in accordance with a dispersion-compensating optical receiving method for a conventional wavelength-multiplex optical transmission receiving system;

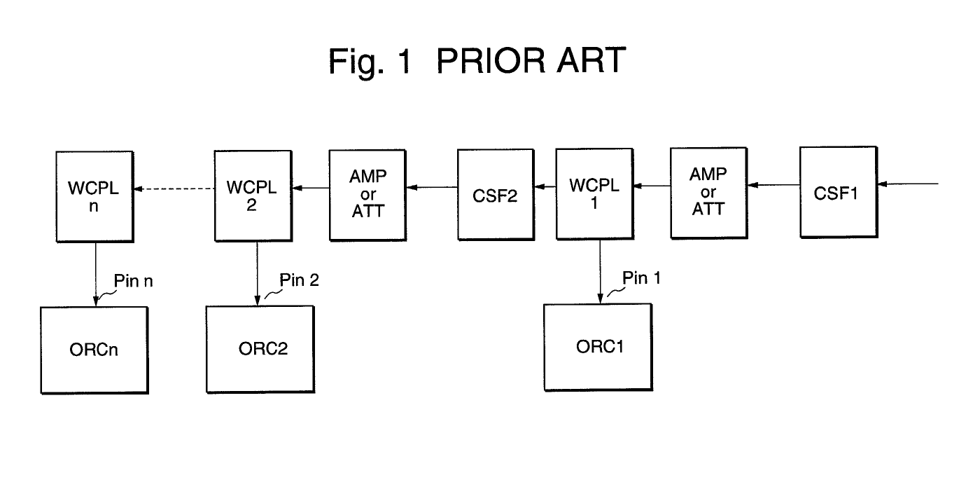

FIG. 2 is a diagram showing design values of the amounts of dispersion compensation in the conventional wavelength-multiplex optical transmission receiving system;

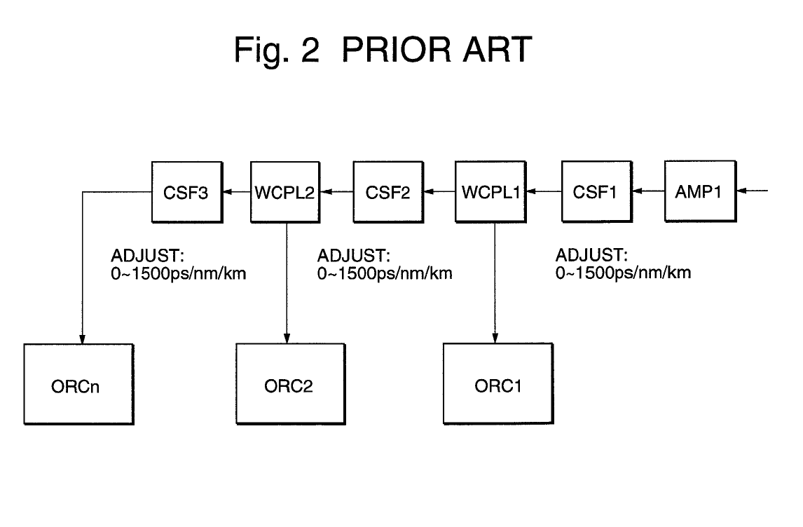

FIG. 3 is a system configuration block and level diagram showing a state after adjustment of the dispersion compensation amounts in the conventional wavelength-multiplex optical transmission receiving system;

FIG. 4 is a system configuration block and level diagram showing a state after different adjustment of the dispersion compensation amounts in the conventional wavelength-multiplex optical transmission receiving system;

FIG. 5 is a block diagram showing the configuration of a first embodiment of a wavelength-multiplex transmission receiving system having an automatic optical level adjuster board in accordance with the present invention;

FIG. 6 is a diagram showing the configuration of an example of a fiber grating wavelength demultiplexing device;

FIG. 7 is a block diagram of the configuration of a first embodiment of the automatic optical level adjuster board in accordance with the present invention;

FIG. 8 is a block diagram of the configuration of a second embodiment of the automatic optical level adjuster board in accordance with the present invention;

FIG. 9 is a block diagram of the configuration of a third embodiment of the automatic optical level adjuster board in accordance with the present invention;

FIG. 10 is a block diagram showing the configuration of a second embodiment of the wavelength-multiplex transmission receiving system having the automatic optical level adjuster board in accordance with the present invention; and

FIG. 11 is a block diagram showing the configuration of a third embodiment of the wavelength-multiplex transmission receiving system having the automatic optical level adjuster board in accordance with the present invention.

### DETAILED DESCRIPTION OF THE PREFERRED EMBODIMENTS

Embodiments of the present invention will be described with reference to the accompanying drawings.

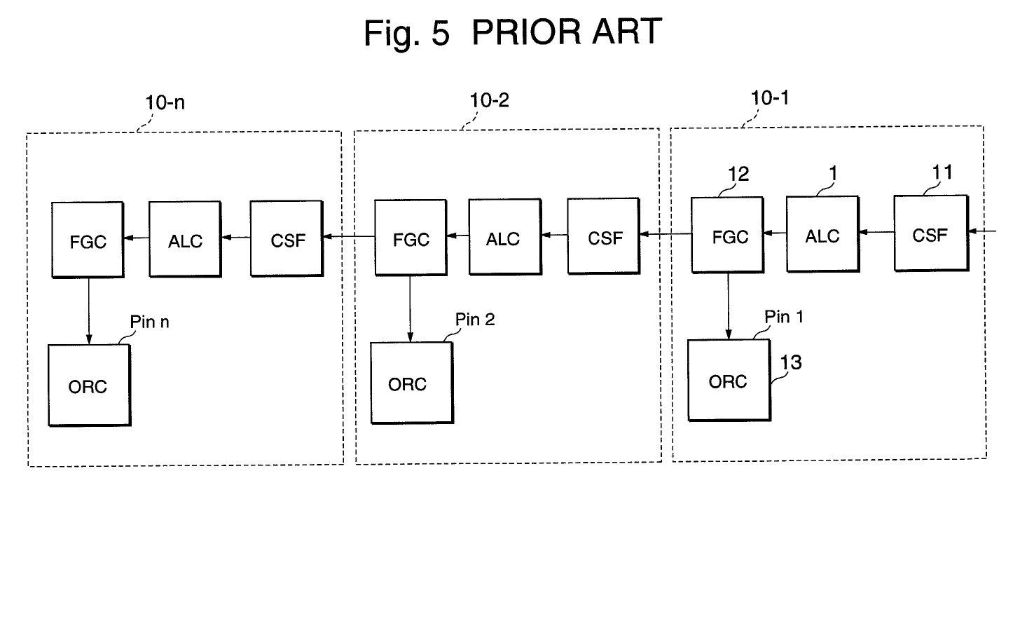

FIG. 5 shows the configuration of a first embodiment of a wavelength-multiplex optical transmission receiving system using an automatic optical output level adjuster board (ALC) in accordance with the present invention. This wavelength-multiplex optical transmission receiving system is formed by placing dispersion-compensating optical receiving modules 10 in an n-stage cascade arrangement. Each of the dispersion-compensating optical receiving modules 10 shown in the blocks indicated by broken lines is constituted by one of n fiber grating wavelength demultiplexing device (FGC) 12 provided as wavelength demultiplexing means for wavelength-separating optical signals of desired wavelengths from a wavelength-multiplexed optical signal of n wavelengths, a dispersion compensating fiber (CSF) 11, an optical signal receiver (ORC) 13 for receiving the optical signal wavelength-separated by the FGC 12, and an automatic optical level adjuster board 1 for compensating for an optical attenuation due to insertion of the CSF. The dispersion compensating optical receiving modules 10 separate and receive optical signals of desired wavelengths from a wavelength-multiplexed optical signal while compensating the signals for dispersions.

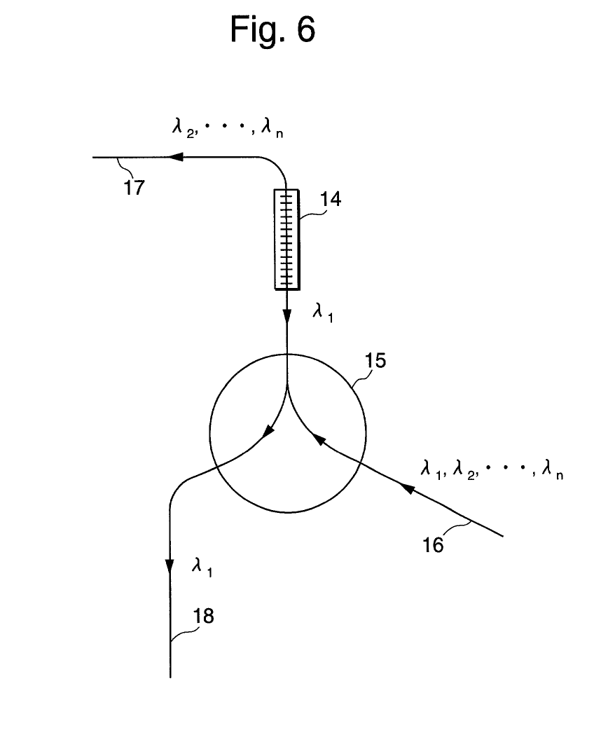

The FGC is constituted by, for example, a fiber grating 14 and a three-terminal optical circulator 15, as shown in FIG. 6. Of an n-wave-multiplexed optical signal input through an input end 16, only a particular wavelength, which is λ1 in this example, is reflected by the fiber grating 14. The λ1 optical signal is output through an output end 18 to propagate to the optical signal receiver 13. The rest of the wavelength-multiplexed signal from which λ1 has been selectively removed is output through another output end 17 to be input to the dispersion-compensating optical receiving module 10-2 in the next stage.

In this wavelength-multiplexed optical transmission receiving system, the automatic optical output level adjuster board ALC1 capable of outputting an always constant optical level regardless of the input level in accordance with the present invention is provided in the dispersion-compensating optical receiving module 10 in each stage. Therefore, the level of optical input Pin to the optical signal receiver is constant with respect to any wavelength irrespective of the amount of optical attenuation in the dispersion compensating fiber, which varies depending on the set dispersion compensation amount, and it is possible to ensure recovery from deterioration in waveform caused by the dispersion compensating fiber as well as stable reception of optical signals. Preferably, the input optical level Pin is set to the optimum light receiving level of the optical signal receiver.

The automatic optical output level adjuster board in accordance with the present invention will be described in detail.

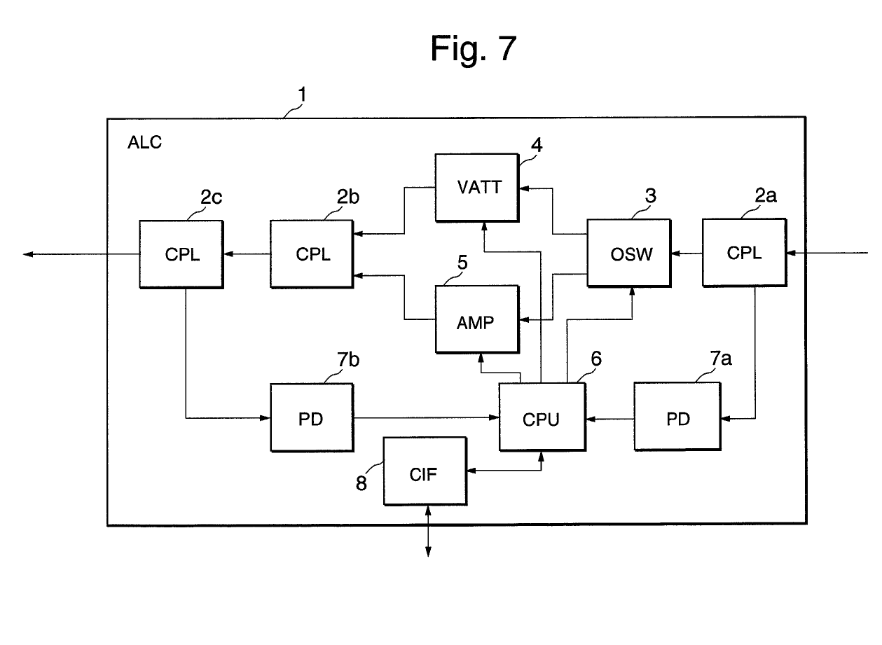

FIG. 7 is a block diagram showing a first embodiment of the automatic optical output level adjuster board in accordance with the present invention. The automatic optical output level adjuster board ALC is constituted by three optical couplers (CPL) 2a to 2c for branching an optical signal, an optical switch OSW3 for changing paths for the optical signal, a variable attenuator (VATT) 4 for attenuating the optical signal, a variable optical amplifier AMP 5 for amplifying the optical signal, photodetectors PD 7a and PD 7b for receiving light and outputting a current value which changes according to the level of the received light, a central processing unit (CPU) 6 for control, and a communication interface CIF 8 for communication with an external device.

Referring to FIG. 7, an optical input is distributed to the optical switch OSW 3 and to the photodetector PD 7a by branching in the optical coupler CPL 2a. The PD 7a converts the level of the received optical signal into an electrical signal. The CPU 6 reads the received light level from the PD 7a and outputs the optical signal to the VATT 4 if the received light level from the PD 7a is larger than a prescribed output value, or to the AMP 5 if the received light level from the PD 7a is equal to or smaller than the prescribed output value, which is set as described below, for example. In the wavelength-multiplex optical transmission receiving system using in each dispersion-compensating optical receiving module 10-1 the automatic optical output level adjuster board ALC shown in FIG. 7, if a level of light Pin 1 input to the optical signal receiver ORC 13 is the optimum light receiving level of the ORC 13, and if the total sum of optical losses due to insertion of all the optical components in the optical path as reversely seen from the ORC 13 to the optical signal input of the ALC 1 is “A” dB, the prescribed value is Pin 1 (dBm)+A dB. The OSW 3 may switch the optical path in the automatic output level adjuster board ALC 1 to the AMP 5 if the optical signal input is equal to or smaller than this prescribed value (Pin 1 (dBm)+A dB), or to the VATT 4 if the optical signal input is larger than this prescribed value.

The output paths from the VATT 4 and AMP 5 are combined into one to enable the optical signal supplied either to the VATT 4 or to the AMP 5 to be output to the CPL 2c. The input signal is distributed to the output end of the ALC 1 and to the PD 7b by branching in the optical coupler CPL 2c. The PD 7b converts the level of the received optical signal into an electrical signal. The CPU 6 reads the received light level from the PD 7b and controls the amount of attenuation by the VATT 4 or the gain of the AMP 5 so that the value of the received light level is equal to a prescribed value of the ALC output, thereby maintaining the level of optical output from the ALC 1 at the constant value. This prescribed value of the optical signal output can be calculated from the above-mentioned optimum light receiving level of the optical signal receiver.

The prescribed value of the optical signal input and the prescribed value of the optical signal output may be stored in the CPU 6 in advance or may be externally designated through the communication interface CIF 8.

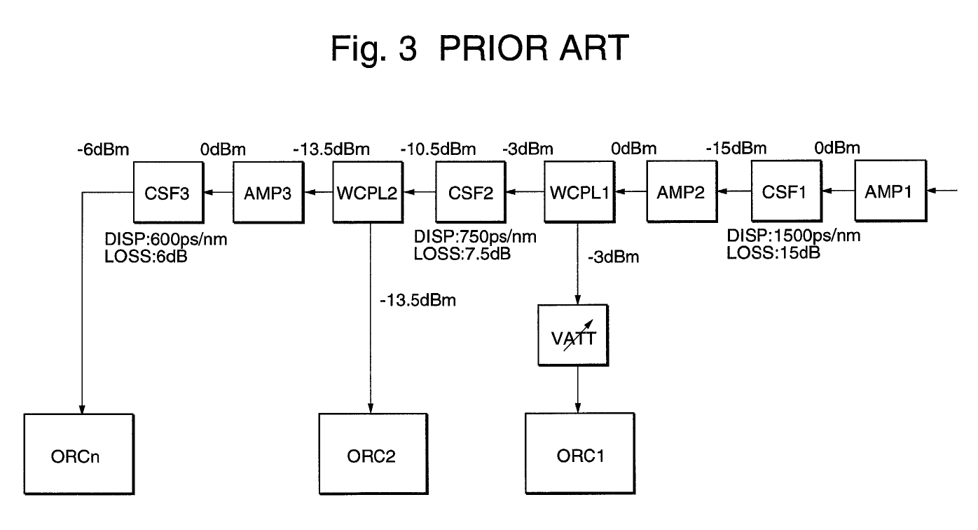

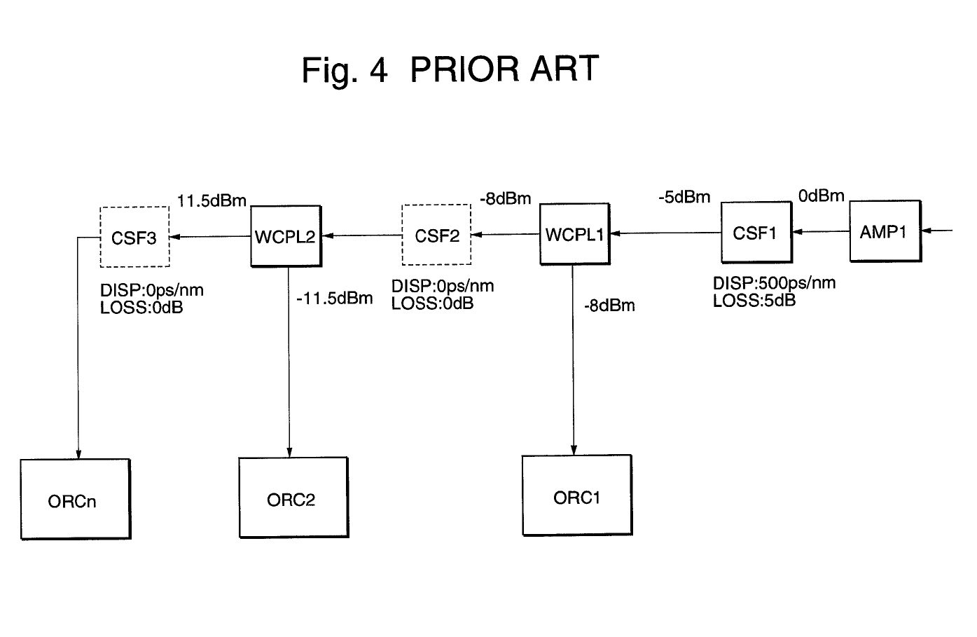

The automatic optical output level adjuster board ALC 1 is arranged as described above to operate so as to output an optical signal always at a constant level regardless of the input optical level. In the wavelength-multiplex optical transmission receiving system using the automatic optical level adjuster board shown in FIG. 5 therefore, any n-stage series connection of dispersion-compensating optical receiving modules 10 is made in only one way regardless of the amounts of dispersion compensation by dispersion compensating fibers. Unlike the conventional systems shown in FIGS. 3 and 4, the wavelength-multiplex optical transmission receiving system of the present invention does not require addition of any other element or removal of any of its components. Also, the system of the present invention does not require the above-mentioned optical output adjustment operations.

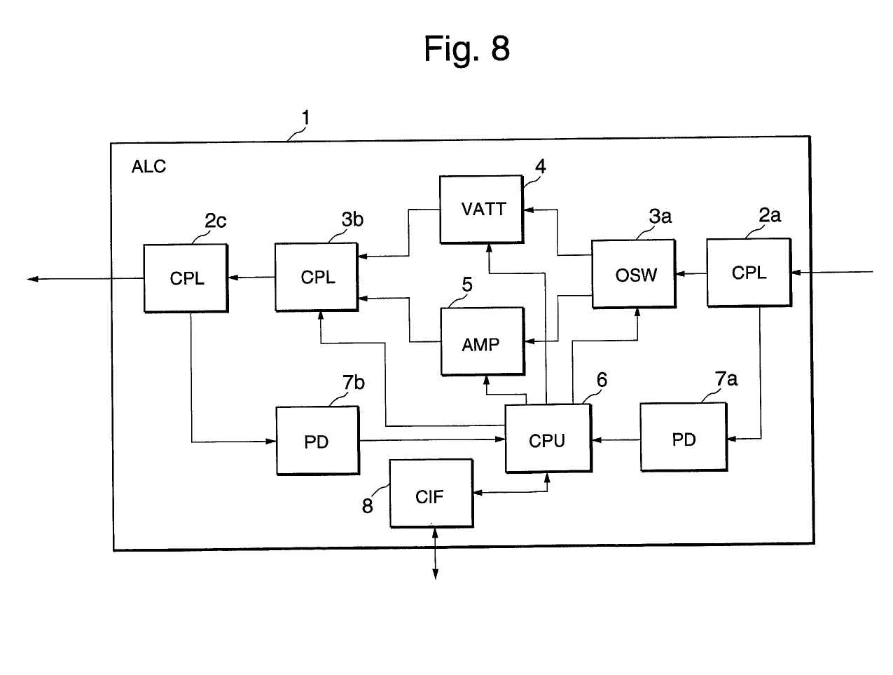

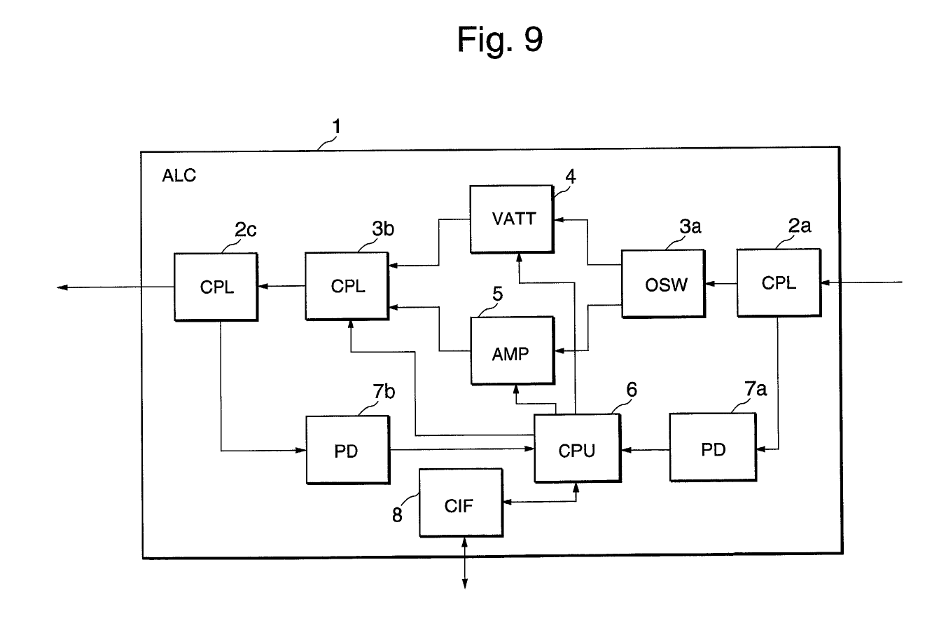

Second and third embodiments of the automatic optical level adjuster board in accordance with the present invention may be realized on the basis of configurations described below. That is, the optical coupler CPL 2b in the first embodiment shown in FIG. 7 may be replaced by an optical switch OSW 3b as shown in FIG. 8. Also, the automatic optical level adjuster board may be arranged in such a manner that, as shown in FIG. 9, the optical switch OSW 3 in the first embodiment shown in FIG. 7 replaced by an optical coupler CPL 2d, while the coupler CPL 2b is replaced with an optical switch OSW3b. The same effect can also be achieved in this manner.

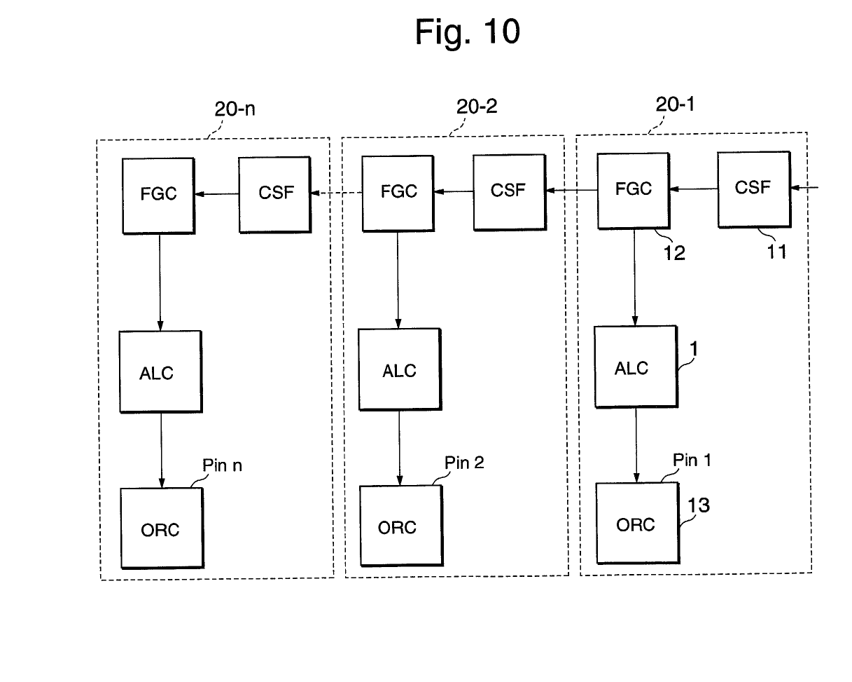

FIG. 10 shows the configuration of a second embodiment of the wavelength-multiplex optical transmission receiving system using the automatic optical output level adjuster board in accordance with the present invention. In this receiving system, dispersion-compensating optical receiving modules 20 shown in the blocks indicated by broken lines are connected in n-stage cascade form. The dispersion-compensating optical receiving module 20-1 is constituted by dispersion compensating fiber CSF 11, FGC 12 for separating a particular wavelength of signal light from wavelength-multiplexed light output from the dispersion compensating fiber and for outputting the separated wavelength of light to the dispersion-compensating optical receiving module 20-2 in the following stage, automatic optical output level adjuster board ALC 1 arranged in accordance with the present invention to adjust the level of the separated optical signal having the particular wavelength and to output the level-adjusted optical signal, and optical signal receiver ORC 13 for receiving the optical signal having the particular wavelength and having its level adjusted to a predetermined level by the ALC 1.

This wavelength-multiplexed optical transmission receiving system is also constituted by the automatic optical output level adjuster board ALC1 of the present invention capable of outputting an always constant optical level regardless of the input level, as is the first embodiment receiving system shown in FIG. 5. Therefore, the level of optical input to the optical signal receiver ORC is constant with respect to any wavelength irrespective of the amount of optical attenuation in the dispersion compensating fiber CSF, which varies depending on the set dispersion compensation amount, and it is possible to ensure recovery from deterioration in waveform caused by the dispersion compensating fiber as well as stable reception of optical signals.

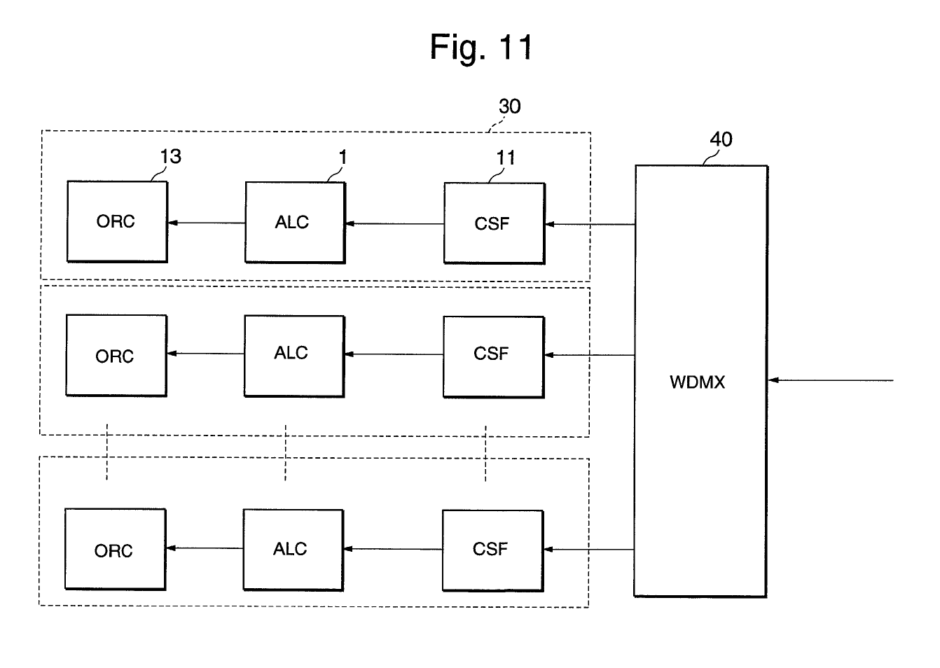

FIG. 11 shows the configuration of a third embodiment of the wavelength-multiplex optical transmission receiving system using the automatic optical output level adjuster board in accordance with the present invention. This receiving system has an wavelength demultiplexing device WDMX 40 which separates a wavelength-multiplexed optical signal into optical signals of different wavelengths and outputs the separated optical signals in parallel with each other, and dispersion-compensating optical receiving modules 30 arranged in n parallel rows. Each of the dispersion-compensating optical receiving module 30 shown in the blocks indicated by broken lines is constituted by dispersion compensating fiber CSF 11, automatic optical output level adjuster board ALC 1 for adjusting the level of an optical signal of a particular wavelength output from CSF 11 and outputting the level-adjusted optical signal, and optical signal receiver ORC 13 for receiving the optical signal having the particular wavelength and having its level adjusted to a predetermined level by the ALC 1.

The wavelength demultiplexing device WDMX 40 used in this embodiment may be a spectroscopic device formed in such a manner that FGCs each formed of the combination of the fiber grating and the optical circulator shown in FIG. 6 are arranged in a cascade form, an arrayed waveguide Bragg diffraction grating type of spectroscopic device (AWG) based on an application of the principle of spectrography using a diffraction grating to an optical waveguide type of device, a spectroscopic device using multiple reflection interference caused by a dielectric multilayer film, or the like.

This wavelength-multiplexed optical transmission receiving system is also constituted by the automatic optical output level adjuster board of the present invention capable of outputting an always constant optical level regardless of the input level, as is the first or second embodiment system. Therefore, the level of optical input to the optical signal receiver is constant with respect to any wavelength irrespective of the amount of optical attenuation in the dispersion compensating fiber, which varies depending on the set dispersion compensation amount, and it is possible to ensure recovery from deterioration in waveform caused by the dispersion compensating fiber as well as stable reception of optical signals.

As described above, the automatic optical level adjuster board of the present invention is capable of outputting an optical signal always at a constant level regardless of the input level. In the wavelength-multiplex optical transmission receiving system comprising the tandem connection of the dispersion compensating fiber, the automatic optical output level adjuster board and the light branching and receiving means, therefore, the level of light input to the optical receiver is constant with respect to any wavelength irrespective of the amount of optical attenuation by the dispersion compensating fiber, which varies depending on the set dispersion compensation amount, so that it is possible to ensure recovery from deterioration in waveform caused by the dispersion compensating fiber as well as stable reception of optical signals. Only one device configuration suffices irrespective of the amount of dispersion compensation by the dispersion compensating fiber, and there is no need to add any other element or remove any of the component devices. Also, there is no need for optical output adjustment operations such as those required in the conventional art.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. An optical signal receiving system in which a receiving signal light which is transmitted through a single mode fiber having a zero-velocity-dispersion wavelength and has a wavelength different from the zero-dispersion wavelength, is received while performing dispersion compensation on the signal light, said system comprising:
optical receiving means; and
automatic optical level adjustment means for automatically adjusting always to a predetermined level the level of optical signal to be received by said optical receiving means when the amount of dispersion compensation on the signal light is newly set.

2. A system according to claim 1, wherein said optical signal is a wavelength-multiplexed optical signal; a plurality of said light receiving means is provided; and said automatic optical level adjustment means is provided in combination with each of the plurality of said light receiving means.

3. A system according to claim 1, wherein said predetermined level is of an optimum light receiving level of said light receiving means.

4. An automatic optical level adjuster for automatically adjusting always to a predetermined level the level of a signal to be received by light receiving means, said adjuster comprising:
a variable optical attenuator for changing the amount of attenuation of light on the basis of first control information;
a variable optical amplifier for variably producing an optical output according to second control information;
optical switch means for switching on the basis of third information between an output optical path for output of input light by transmission through said variable optical attenuator and an output optical path for output of input light by transmission through said variable optical amplifier; and
control means for controlling the level of light output from each of said output optical paths to a preset level by outputting the third control information from comparison information obtained by comparing the level of the input light with a preset level, and the first or second control information from comparison information obtained by comparing the level of light output from said output optical path with a preset level.

5. An adjuster according to claim 4, wherein the level preset with respect to the input light and the level preset with respect to the light are stored in said control means.

6. An adjuster according to claim 4, wherein the level preset with respect to the input light and the level preset with respect to the light are set from the outside of said adjuster.

7. An adjuster according to claim 4, wherein said optical switch means comprises:
a one-input two-output optical switch for selectively inputting the input light to said variable optical attenuator or said variable optical amplifier; and
an optical coupler for combining the output of said variable optical attenuator and the output of said variable optical amplifier into one output.

8. An adjuster according to claim 4, wherein said optical switch means comprises:
a one-input two-output optical switch for selectively inputting the input light to said variable optical attenuator or said variable optical amplifier; and
a two-output one-input optical switch for selectively establishing a connection for obtaining one output from the output of said variable optical attenuator and the output of said variable optical amplifier.

9. An adjuster according to claim 4, wherein said optical switch means comprises:
a one-input two-output optical branching device for simultaneously inputting the input light to said variable optical attenuator and to said variable optical amplifier; and
a two-output one-input optical switch for selectively establishing a connection for obtaining one output from the output of said variable optical attenuator and the output of said variable optical amplifier.

10. A system according to claim 1, wherein said automatic optical level adjustment means comprises:
a variable optical attenuator for changing the amount of attenuation of light on the basis of first control information;
a variable optical amplifier for variably producing an optical output according to second control information;
optical switch means for switching on the basis of third information between an output optical path for output of input light by transmission through said variable optical attenuator and an output optical path for output of input light by transmission through said variable optical amplifier; and
control means for controlling the level of light output from each of said output optical paths to a preset level by outputting the third control information from comparison information obtained by comparing the level of the input light with a preset level, and the first or second control information from comparison information obtained by comparing the level of light output from said output optical path with a preset level.

11. A system according to claim 2, further comprising dispersion-compensating light receiving means forming a plurality of stages, said dispersion-compensating light receiving means comprising:
dispersion compensation means for performing dispersion compensation on the wavelength-multiplexed input signal light;
said automatic optical level adjustment means through which output light from said dispersion compensation means is transmitted;
wavelength demultiplexing means for separating output light from said automatic optical level adjustment means into first light which is signal light of a particular wavelength and second light left after removal of the first light; and
said light receiving means for receiving the first light,
wherein said dispersion-compensating light receiving means in the plurality of stages are connected in cascade form such that the second light in one of the stages is supplied as the input signal light to said dispersion compensation means in the following stage.

12. A system according to claim 11, wherein said wavelength demultiplexing means comprises a fiber grating for reflecting the first light, and an optical circulator.

13. A system according to claim 12, wherein said optical circulator has three terminals.

14. A system according to claim 2, further comprising dispersion-compensating light receiving means forming a plurality of stages, said dispersion-compensating light receiving means comprising:
dispersion compensation means for performing dispersion compensation on the wavelength-multiplexed input signal light;
wavelength demultiplexing means for separating output light from said dispersion compensation means into first light which is signal light of a particular wavelength and second light left after removal of the first light;
said automatic optical level adjustment means through which the first light is transmitted; and
said light receiving means for receiving the light transmitted through said automatic optical level adjustment means,
wherein said dispersion-compensating light receiving means in the plurality of stages are connected in cascade form such that the second light in one of the stages is supplied as the input signal light to said dispersion compensation means in the following stage.

15. A system according to claim 14, wherein said wavelength demultiplexing means comprises a fiber grating for reflecting the first light, and an optical circulator.

16. A system according to claim 15, wherein said optical circulator has three terminals.

17. A system according to claim 2, further comprising:
wavelength demultiplexing means for obtaining parallel wavelength demultiplexing outputs from a wavelength-multiplexed input signal;
a plurality of dispersion compensation means for performing said dispersion compensation on the output light from said wavelength demultiplexing means;
a plurality of said automatic optical level adjustment means through each of which output light from the corresponding one of said dispersion compensation means is transmitted; and
a plurality of said light receiving means each for receiving output light from the corresponding one of said automatic optical level adjustment means.

18. A system according to claim 17, wherein said wavelength demultiplexing means comprises an arrayed waveguide Bragg diffraction grating type of wavelength demultiplexing device (AWG).

19. A system according to claim 17, wherein said wavelength demultiplexing means comprises a wavelength demultiplexing device having a plurality of stages formed by optical filters using a dielectric multilayer film.

20. A system according to claim 17, wherein said wavelength demultiplexing means comprises a device having a plurality of stages each formed of a combination of a fiber grating and an optical circulator.

21. A system according to claim 20, wherein said optical circulator has three terminals.
